(19) United States
(12) Patent Application Publication
(10) Pub. No.: US 2018/0014360 A1
(43) Pub. Date: Jan. 11, 2018

(54) DUAL HEATING APPARATUS

(71) Applicant: Check Corporation, Troy, MI (US)

(72) Inventor: Richard D. Larpenteur, St. Clair Shores, MI (US)

(21) Appl. No.: 15/643,949

(22) Filed: Jul. 7, 2017

Related U.S. Application Data
(60) Provisional application No. 62/359,983, filed on Jul. 8, 2016.

(51) Int. Cl. H05B 3/34; H05B 1/02

(52) U.S. Cl. CPC H05B 3/342; H05B 1/0238

(57) ABSTRACT

In at least some implementations, a heating apparatus includes a first temperature control source having a first substrate and a first heating element that is coupled to the first substrate, and a second temperature control source having a second substrate, and a second heating element that is coupled to the second substrate. The first and second heating elements are coupled electrically in series with one another. The first heating element may be sewn to the first substrate, and the second heating element may be sewn to the second substrate. An electrical circuit may be defined that includes a single current loop, wherein the first and second heating elements are coupled electrically in series with one another using one or more electrical connection segments.

### REFERENCE TO CO-PENDING APPLICATIONS

This application claims the benefit of U.S. Provisional Patent Application Ser. No. 62/359,983 filed Jul. 8, 2016 which is incorporated herein by reference in its entirety.

### TECHNICAL FIELD

This disclosure relates generally to a heating apparatus having two temperature control sources.

### BACKGROUND

Seats in a motor vehicle may include a built-in heating element that provides heat to the body of the driver or other occupant of the vehicle. The heat is provided by electric current supplied through a conductor having suitable resistivity that ensures the desired amount of heat from the conductor. The heating element can be sandwiched between a top cover member of leather, fabric or plastic material and the foam rubber core portion or padding of the seat.

Seats provided for vehicles used for material handling, earthmoving, or lawn cutting are normally fabricated utilizing an in-mold forming process to reduce the cost of the seat. This type of process provides a seat having a core made of a plastic foam, such as polyurethane foam, that is bonded to an outer decorative cover sheet or skin during the molding process. In the practice of such process, a properly shaped mold cavity is lined with a thin plastic or fabric skin after which liquid polyurethane is poured onto the skin to form an integral seat cushion or seat back. Heating elements may also be provided in such seats.

Seats may include a heating element within a seat back portion of a seat and a separate heating element within the seat bottom portion of the seat. The two heating elements are formed separately and include a wire coupler, junction or splice so that the heating elements are electrically coupled together by joining together the separate wires after the heating elements are separately formed.

Containers for food and other items (e.g. blankets) may also include heating elements. Sometimes the containers have two heating elements that are spaced apart and received adjacent to separate walls of the container. The two heating elements are formed separately and include a wire coupler, junction or splice so that the heating elements are electrically coupled together by joining together the separate wires after the heating elements are separately formed.

### SUMMARY

In at least some implementations, a heating apparatus includes a first temperature control source having a first substrate and a first heating element that is coupled to the first substrate, and a second temperature control source having a second substrate, and a second heating element that is coupled to the second substrate. The first and second heating elements are coupled electrically in series with one another. The first heating element may be sewn to the first substrate, and the second heating element may be sewn to the second substrate. An electrical circuit may be defined that includes a single current loop, wherein the first and second heating elements are coupled electrically in series with one another using one or more electrical connection segments. Each of the first and second heating elements may be coupled to the first and second substrates, respectively, in a meandering pattern so that no portion of the respective first or second heating element overlaps itself.

In at least some implementations, both the first and second heating elements are defined by a single, continuous wire. A power connector may be provided through which power is supplied to the first and second heating elements, and the wire of the first and second heating elements may have at least one end connected to the power connector. A sensor may be provided and the wire of the first and second heating elements may include an end connected to the sensor. The sensor and power connector may be in series and a wire segment may extend from the sensor to the power connector. The wire may include at least one strain relief element, and the strain relief element may be fixed to the substrate.

The first temperature control source may include a frame to which the substrate is attached, and the frame may include a gap or passage through which part of the first heating element passes. The substrate may include first and second layers that are positioned on opposite sides of the frame, and the heating element may be disposed between the first and second layers of the substrate. A metallic layer may be received between the first and second layers. The frame may include an opening and the heating element may be laid out within the opening of the frame such that the frame peripherally surrounds at least part of the heating element, and the substrate may be coupled to the frame and overlie the heating element.

In at least some implementations, an apparatus includes a first control compartment, a second control compartment, a first temperature control source received within the first control compartment and having a first substrate and a first heating element that is coupled to the first substrate, and a second temperature control source having a second substrate, and a second heating element that is coupled to the second substrate. The first and second heating elements are coupled electrically in series with one another. Both the first and second heating elements may be defined by a single, continuous wire. The wire may include a first portion coupled to the first substrate in a meandering pattern, a second portion coupled to the second substrate in a meandering patter and a third portion extending between the first substrate and the second substrate.

### BRIEF DESCRIPTION OF THE DRAWINGS

The following detailed description of preferred embodiments and best mode will be set forth with reference to the accompanying drawings, in which:

FIG. 1 is a rear perspective view of a portable food delivery container showing an access panel in an open position and two temperature control sources in a partially inserted state;

FIG. 2 is a plan view of the control sources shown in FIG. 1 wherein an upper substrate layer of each control source is hidden to illustrate components therein; and

FIG. 3 is a sectional view of one of the temperature control sources along section lines 3-3 of FIG. 2.

### DETAILED DESCRIPTION

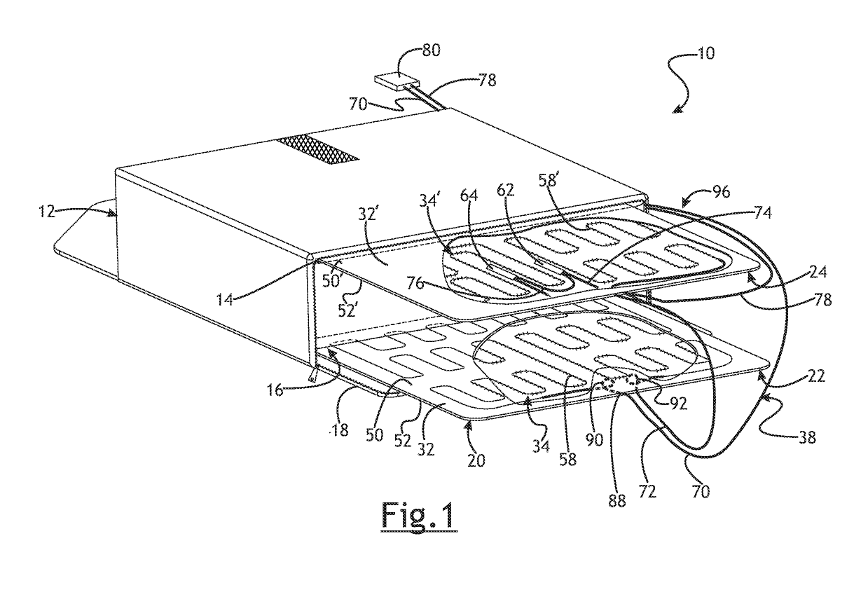

Referring in more detail to the drawings, FIG. 1 shows a portable food delivery container 10 that includes a food storage compartment 12, upper and lower control compartments 14, 16 accessible via an open access panel 18, and a heating apparatus 20 having two temperature control sources 22, 24. The container 10 may be used, for example, to keep food items within a desired temperature range during storage and/or delivery. The food items typically are prepared at a restaurant, such as a delivery/carry-out pizza shop, placed within the food storage compartment 12, and then delivered to a customer. The temperature of the stored food items can then be maintained within a desired temperature range inside the compartment 12 by the heat provided from the temperature control sources.

Depending on the application in which the container 10 is used, the food storage compartment 12 may be maintained warmer than the ambient temperature. For instance, a pizza, hot sandwich, or other hot food or beverage item may be kept at a temperature well above ambient so it will be relatively warm or hot when delivered. Of course, portable container 10 can be used for non-food items as well. For example, there are many non-food items that should be stored and transported at a temperature other than room temperature. Medical items like blankets for hypothermia victims may be transported and kept above room temperature, while other medical items like certain medicines may need to be transported and kept below room temperature. Therefore, the illustrated container is merely an example, and other containers may be used having different shapes, sizes, or both.

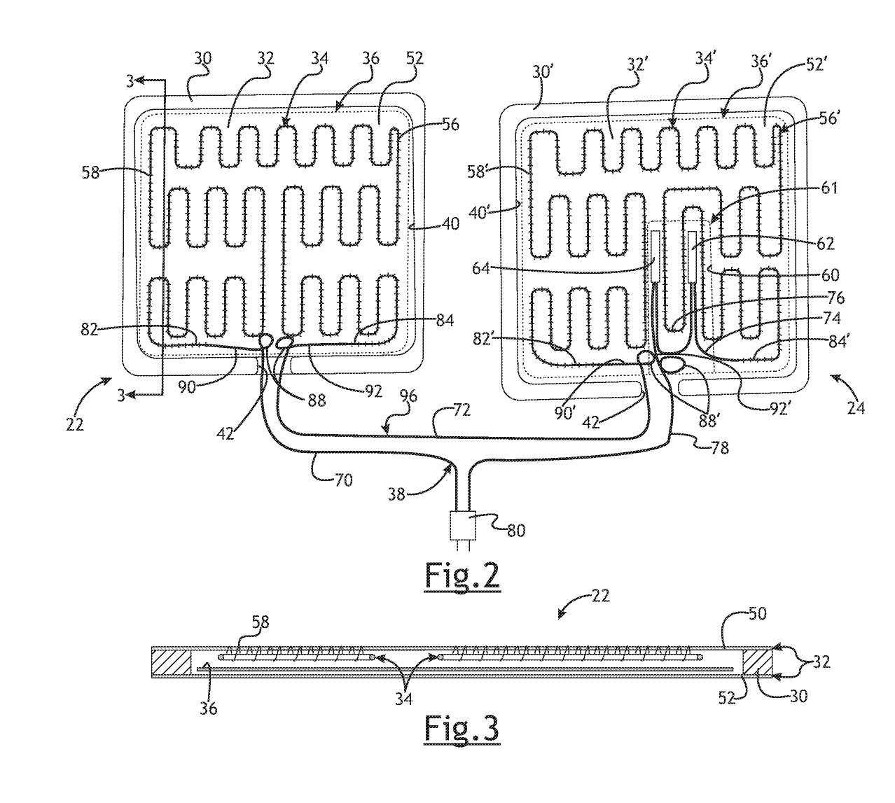

The heating apparatus 20 for the container 10 includes a first heating member or temperature control source 22 electrically coupled to a second heating member or temperature control source 24. In at least one embodiment, the first and second temperature control sources 22, 24 have at least some similar features; therefore, only one of the sources (22) will be described. For example, as shown in FIGS. 2-3, the first control source 22 includes a frame 30, a carrier or substrate 32, a conductor or heating element 34, an optional foil or metallic layer 36, and an electrical connection 38. Similar or identical features (of source 24) are identified using like or similar reference numerals.

The frame 30 is adapted to give the first control source 22 shape, form, and at least some rigidity so that the control source 22 can be slidably inserted and/or removed from its respective control compartment 16 in container 10 (FIG. 1). In the illustrated embodiment of FIG. 2, frame 30 generally is made of a semi-rigid plastic (e.g., nylon) having an open rectangular shape that may define an outer perimeter of the control source and has a desired width between an outer surface and an inner surface to provide an open interior or central region within the inner surface of the frame. An opening or central region 40 of the frame 30 is sized to receive the conductor 34 which may be wound or otherwise routed within the central region according to a predetermined or pre-configured pattern. The frame 30 further may include a gap or passage 42 sized to permit the electrical connection 38 to pass therethrough, as described more below. The frame shown in FIG. 2 merely illustrates one example; frames having other shapes, sizes, and materials also can be used.

As shown in FIGS. 1 and 3, the substrate 32 may be a planar sheet comprising a first or upper layer 50 and a second or lower layer 52. The layers 50, 52 may be positioned on opposite sides of the frame 30 and may have the same or similar size and shape as the frame 30 (and may be adhered or bonded thereto). For example, FIG. 1 illustrates a portion of the upper layer 50 cut-away, while in FIG. 2, the upper layer 50 is entirely hidden to illustrate components typically enclosed between the two layers 50, 52. Layers 50, 52 may be adapted to isolate the conductor 34 from direct contact with surfaces within the compartment 16 (or 14)—e.g., to avoid uneven heat distribution, hotspots, and to protect the conductor 34. In addition, as will be explained below, at least one of the layers (e.g., layer 52 in the illustrations) may carry or be coupled to the conductor 34—e.g., preventing it from moving or being displaced between the layers 50, 52. Upper and lower layers 50, 52 may be identical and may comprise or be constructed of felt material, and according to at least one embodiment, upper and lower felt layers 50, 52 may promote an even or uniform distribution of heat from the conductor(s), as described below. The felt material may include natural fibers, synthetic fibers, or both; further, textiles other than felt could be used instead.

The conductor 34 may be any element that radiates heat sufficient to warm compartment 12 of container 10 when control source 22 is located in compartment 16 and an electric current is passed therethrough. In at least one implementation, the conductor 34 is made of a low-power resistive material (e.g., metal, polymer, etc.) and has any suitable cross-sectional shape (e.g., the wire may be round, flat, etc. Further, in wire implementations, conductor 34 may be a solid-core wire or may include multiple strands. In at least one embodiment, the size of conductor 34 is within a range of 0.6 millimeters (mm) to 1.2 mm. An exterior surface of conductor 34 may have a fire-resistant coating, oxidation, or the like (e.g., such as lacquered stranded heating wire—e.g., each strand having a coating thereon). Other embodiments are also possible, including higher power implementations.

As will be described more below, the heating apparatus 20 may be adapted to operate when coupled to a suitable power source (e.g., a direct 12 Volt (V) supply); thus, in one embodiment, the conductor 34 may be characterized by its electrical properties. For example, the resistance of the conductor 34 may be 0.226 Ohms per meter (Ω/m) to 2 Ω/m and may radiate heat between 100°-200° F. Of course, this is merely one implementation; other resistance ranges may be used instead.

As shown in FIGS. 1 and 2, conductor 34 may be a continuous and unitary piece of material arranged in a circuitous manner to increase the amount of conductor in a control source and to evenly distribute the conductor about the control source. The wire may be arranged in a planar, switched-back or planar, meandering pattern 56. In at least one embodiment, the pattern 56 is arranged so that no portion of the conductor 34 overlaps itself, so that adjacent portions of the conductor 34 are generally evenly spaced from one another, and so that conductor 34 generally is evenly distributed within the opening 40 of the frame 30. Of course, the illustrated pattern 56 is merely an example; and other embodiments also exist. In at least one preferred embodiment, the pattern 56 is configured to provide a generally even heat distribution within the storage compartment 12 (e.g., by providing even heat through layers 50 or 52).

By sewing or stitching conductor 34 to one of the layers 50, 52, the pattern 56 may be fixed or retained during use or shipment of the control source 22. In one embodiment, the conductor 34 is sewn to lower layer 52 of the substrate 32 using an element 58 such as heat-resistive string, thread, twine, or the like. One commercially-available sewing or stitching implementation is commonly referred to as ‘lay-stitching’ where a lay-stitch machine sews the conductor 34 to the substrate 32 using thread 58 so that conductor 34 abuts substrate 32. However, lay-stitching is merely one non-limiting example. Coupling by sewing or stitching may better retain the conductor 34 between the substrate layers 50, 52—e.g., as opposed to the conventional use of only an adhesive to retain the conductor 34. This is particularly true, for example, when container 10 is used to carry items that may spill or leak. For example, food and beverage spillage or leakage may weaken or decay the strength of adhesives thereby permitting the conductor 34 to dislodge from the substrate 32 and bunch or cluster together between the layers 50, 52 thereby creating hotspots and uneven heat distribution.

Even heat distribution from control sources 22, 24 further may be promoted by use of a thermally conductive layer (e.g., in addition to using conductor pattern 56). For example, in at least one embodiment, an optional foil or metallic layer 36 may have a size and shape that approximates the size and shape of opening 40, and layer 36 is located between conductor 34 and upper layer 52. Foil layers 36, 36′ can be generally rectangular; however, foil layer 36′ (control source 24) may have a void 60 that extends inwardly from a periphery thereof. It will be appreciated that the prime symbol (added to element 36 (e.g., 36′) and to other elements below) is intended merely to differentiate components of source 24 from those of source 22, for ease of description. As explained more below, void 60 provides an area for sensing elements or sensors 61 to be exposed (i.e., not in contact with the foil layer 36′). In at least one implementation, foil layers 36, 36′ may be desirable when the first and second control sources 22, 24 are arranged vertically within container 10, as opposed to horizontally, as shown in FIG. 1. For example, empirical data indicates, in a vertical orientation, at least one foil layer in each control source 22 or 24 provides a more even heat distribution in vertical storage compartments.

In at least one embodiment, at least one of the control sources 22, 24 has one or more sensors or temperature sensitive elements 61 (e.g., such as a bi-metal thermostat device). For example, two sensors 61 may be located between layers 50′, 52′ of control source 24 (FIG. 1). More specifically, two sensors (e.g., thermostat devices 62, 64) are coupled electrically in series with conductor 34′ and electrical connection 38, as discussed below. In at least one implementation, thermostat device 62 is adapted to cycle ON and OFF in order regulate environmental temperature (e.g., within the storage compartment 12), and thermostat device 64 is adapted to be a safety shutoff or switch (e.g., providing an open circuit or the like in the event the thermostat device 64 exceeds a predetermined maximum temperature threshold). This of course is merely an example; and other embodiments exist (e.g., including implementations where sensor(s) 61 are located in control source 22, the heating apparatus 20 has more or fewer sensors 61, etc.).

The electrical connection 38 may include a number of electrically conductive wire segments or links 70-78 to couple the first and second control sources 22, 24 to one another, to couple thermostat device 62, 64 to conductors 34, 34′, and to couple control sources 22, 24 to a power source (not shown) via a power connector 80. For example, in one embodiment, segments 70-78 may be jacketed or insulated conductive wire sized approximately 16-24 gauge (AWG), and the temperature of segments 70-78, as a result of electrical current passing therethrough, may not vary more than a thermal threshold (e.g., 5° F.) from an ambient temperature. Of course, this is merely one implementation; other resistance and/or thermal thresholds may be used instead.

As best shown in FIG. 2, the segments 70-78 may be arranged to couple conductors 34, 34′ in series. Segment 70 may pass through gap 42 and couple a first end 82 of conductor 34 with connector 80. Segment 72 also may pass through gap 42 and gap 42′ coupling a second end 84 of conductor 34 with a first end 82′ of conductor 34′. Segment 74 (within control source 24) may couple a second end 84′ of conductor 34′ with thermostat device 62. Segment 76 may couple thermostat device 62 to thermostat device 64, and segment 78 may pass through gap 42′ coupling thermostat device 64 to power connector 80. Couplings of the segments 70-78 to the conductors 34, 34′, to the thermostat devices 62, 64, and to the connector 80 may include soldered or welded connections, snap-fit connections, or the like, just to list a couple non-limiting examples.

In at least one embodiment, segments 70, 72 (e.g. in heating elements 34, 34′) may have at least one strain relief element 88 located within gap 42 or inboard thereof (as shown in FIG. 2). Element 88 may be a fastener, a clip, electrical tape, or any other suitable means for fixing a local region 90 of segment 70 to a corresponding local region 92 of segment 72. According to one exemplary embodiment (as best shown in FIG. 2), the strain relief element 88 may include loops in segments 70, 72 which are fixed to layer 50, layer 52, or both (e.g., by pressure-sensitive adhesive or PSA, as discussed more below). Segments 72, 78 may have at least one similar strain relief element 88′ at respective regions 90′, 92′. In general, strain relief elements 88, 88′ inhibit the separation, damage, or breaking of soldered connections, snap-fit connections, etc. For example, as explained more below, during use, electrical connection 38 may be pulled or tugged away from control source 22 and strain relief element 88 may inhibit electrical separation or short between conductor end 82 and segment 70 and/or separation or short between conductor end 84 and segment 72. These strain relief examples are intended to be merely illustrative, and other examples in heating apparatus 20 also exist.

When the segments 70-78 are arranged as shown and described, an electrical circuit 96 has a single current loop or electrical circuit path. Thus, current may flow through the circuit 96 in series from connector 80 through segment 70, conductor 34, segment 72, conductor 34′, segment 74, sensor 62, segment 76, sensor 64, and segment 78 to connector 80 again (or vice-versa). In such an arrangement, in one embodiment, the combined resistivity of conductors 34, 34′ may be 0.226-2 Ω/m and the resistivity of the segments may be negligible. It should be appreciated that the single current loop design is an improvement over conventional designs. For example, convention circuit designs include at least two current loops—e.g., having four wires coupled to connector 80. The present electrical circuit implementation reduces the number of electrical connection points thereby reducing the quantity of potential failure points.

Assembly of the heating apparatus 20 may include soldering (e.g., solder tinning) the segments 70-78 to the conductors 34, 34′ and the thermostat devices 62, 64 in order to form the electrical circuit 96 having a single, continuous electrical current loop or path. Thereafter, the conductors 34, 34′ may be lay-stitched to lower substrate layers 52, 52′ according to patterns 56, 56′, respectively. In one embodiment, at least the strain relief elements 88, 88′ are bonded or adhered to one or both substrate layers 50, 50′ (and/or 52, 52′); of course, the conductors, portions of some of the segments, etc. also may be adhered to any suitable substrate layers as well (e.g., using PSA).

Next, one side of the frames 30, 30′ may be glued or otherwise attached to each of the respective lower substrate layers 52, 52′ (e.g., using PSA). Segment pair 70, 72 may be routed through frame gap 42 and strain relief element 88 may be applied at the local segment regions 90, 92. This step may be repeated for segment pair 72, 78 at the local segment regions 90′, 92′ (at gap 42′ using relief element 88′).

In at least some implementations, foil layer 36 may be located over the opening 40 (e.g., some implementations do not include foil layer 36). And thereafter, upper substrate layers 50, 50′ may be glued to the other side of frames 30, 30′, respectively, thereby enclosing the foil layer 36, the conductors 34, 34′, and thermostat devices 62, 64 therein. In at least some embodiments, the enclosing step also may include applying adhesive to the foil layer 36, an inwardly-facing surface of substrate layer 50, an inwardly-facing surface of substrate layer 52, or any combination thereof—e.g., to further bond the layers (36, 50, 52) to one another (e.g., using a full-coverage PSA).

Further, heating apparatus 20 may be installed into the container 10—e.g., control device 24 into compartment 14 and control device 22 into compartment 16. In other implementations, this may be reversed. It should be appreciated that the orientation of each respective control source 22, 24 does not affect the performance of the heating apparatus 20 either. For example, upper layer 50 (source 22) may be oriented upwardly (as shown in FIG. 1), or it could be oriented downwardly, without affecting the thermal performance within container 10. The same is true of the orientation of source 24.

The connector 80 and the electrical connection 38 attached thereto (e.g., segments 70, 78) may be routed through container 10 so that the connector 80 is located near an opening of the food storage compartment 12—e.g., through a container passage (not shown) or through some other portion of compartment 12. Once routed, the access panel 18 may be closed and the apparatus 20 is ready for use.

During use, food or other items may be heated within enclosed compartment 12 as connector 80 is coupled to a power source (e.g., an AC-to-DC adapter or vehicle connection). In at least one embodiment, the power source is a 12 Volt source and the heating apparatus 20 draws less than 1 Amp of current; however, other embodiments are possible. While connected to the power source, thermostat device 62 may behave as a regulating switch to control temperature within compartment 12. For example, when the heating apparatus 20 is initially coupled to the power source, the compartment 12 typically is less than a first predetermined temperature threshold; therefore, thermostat device 62 is in a closed circuit state; i.e., the electrical circuit loop of conductors 34, 34′, segments 70-78, and thermostat devices 62, 64 is not interrupted by device 62. However, if the compartment 12 exceeds a second predetermined temperature threshold, device 62 may switch to an open circuit state thereby inhibiting electrical current through the circuit loop, inhibiting further heating of the compartment 12, and therefore allowing the compartment 12 to cool. And when the compartment 12 becomes less than or equal to the first predetermined temperature threshold again, the device 62 may switch to the closed circuit state thereby passing electrical current through the circuit loop and heating compartment 12. During operation, if device 62 malfunctions, thermostat device 64 can interrupt current in the circuit loop causing an open circuit state. Acting as a backup or safety regulating switch, device 64 may switch open in response to a current surge or upon detection of a temperature that exceeds a third predetermined temperature threshold, which is higher than the second predetermined temperature threshold.

As previously discussed, container 10 may be used to warm food or other items during delivery service. Following the delivery, it may be desirable to clean or wash container 10. Before cleaning, heating apparatus 20 may be removed via the access panel 18 and later re-assembled following cleaning. Removal and re-assembly often places substantial strain on the electrical connection segments—e.g., especially segments 70, 72, 78—e.g., they can be pulled, tugged, etc. and control sources 22 and/or 24 may be folded, crushed, or otherwise exposed to shearing forces. And this cleaning process may occur repeatedly. The strain relief elements 88, 88′ may inhibit the current loop of circuit 96 from being broken or otherwise damaged during such removals and reassemblies.

While use of the heating apparatus 20 has been illustrated and described with respect to container 10, this is not required. For example, heating apparatus 20 may be used in other applications as well—e.g., such as vehicle or automotive seating applications. For example, one temperature control source 22 could be located in a seat base while the other temperature control source 24 may be located in a seat back. Further, connector 80 may be coupled to a vehicle power source and/or actuator to control when power is available. Implementations other than containers and vehicle seating are also possible.

Thus, there has been described a heating apparatus for a container or other apparatus and applications (e.g. for a seat) having first and second control compartments each arranged to receive a heating element. In a container, the first and second control compartment may be defined within or associated with different walls of the container. In a seat, the first and second control compartments may be defined within or associated with, for example, the seat base and seat back. The heating apparatus has at least two control sources, and each control source has a heating element. Each heating element can be stitched or sewn to a substrate or material layer of the respective control source. The respective heating elements can be connected in series with one another such that the heating apparatus comprises a single current loop or electrical circuit path. Further, each control source may provide some strain relief for electrical connections between the heating elements so that the control sources may be removed and installed repeatedly within the container without breaking or damaging the electrical loop. And the heating elements may be formed by a single wire that is circuitously routed about a first substrate and a second substrate and extends between and coupled together the first and second substrates. In that regard, the wire may include a first portion coupled to the first substrate in a meandering pattern, a second portion coupled to the second substrate in a meandering patter and a third portion extending between the first substrate and the second substrate. From the second substrate, the wire may be coupled to a power connector, or the wire may be coupled to a sensor and a wire segment may extend from the sensor to the power connector.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A heating apparatus, comprising:
a first temperature control source having a first substrate and a first heating element that is coupled to the first substrate; and
a second temperature control source having a second substrate, and a second heating element that is coupled to the second substrate, wherein the first and second heating elements are coupled electrically in series with one another.

2. The apparatus of claim 1, wherein the first heating element is sewn to the first substrate, wherein the second heating element is sewn to the second substrate.

3. The apparatus of claim 1, further comprising an electrical circuit comprising a single current loop, wherein the first and second heating elements are coupled electrically in series with one another using one or more electrical connection segments.

4. The apparatus of claim 1, wherein at least one of the first or second temperature control sources includes a thermostat device.

5. The apparatus of claim 1, wherein each of the first and second heating elements is coupled to the first and second substrates, respectively, in a meandering pattern so that no portion of the respective first or second heating element overlaps itself, and the first and second heating elements are defined by a single wire that has a first portion coupled to the first substrate, a second portion coupled to the second substrate and a third portion extending between the first substrate and the second substrate.

6. The apparatus of claim 1, wherein each of the first and second temperature control sources include a foil layer adapted to distribute heat from the respective first and second heating elements.

7. The apparatus of claim 1 wherein both the first and second heating elements are defined by a single, continuous wire.

8. The apparatus of claim 1 wherein the first temperature control source includes a frame to which the substrate is attached, and wherein the frame includes a gap or passage through which part of the first heating element passes.

9. The apparatus of claim 8 wherein the substrate includes first and second layers that are positioned on opposite sides of the frame, and wherein the heating element is disposed between the first and second layers of the substrate.

10. The apparatus of claim 8 wherein the frame includes an opening and the heating element is laid out within the opening of the frame such that the frame peripherally surrounds at least part of the heating element, and wherein the substrate is coupled to the frame and overlies the heating element.

11. The apparatus of claim 9 which also includes a metallic layer received between the first and second layers.

12. The apparatus of claim 7 which also includes a power connector through which power is supplied to the first and second heating elements, wherein the wire of the first and second heating elements has at least one end connected to the power connector.

13. The apparatus of claim 12 which also includes a sensor and wherein the wire of the first and second heating elements includes an end connected to the sensor.

14. The apparatus of claim 13 wherein the sensor and power connector are in series and a wire segment extends from the sensor to the power connector.

15. The apparatus of claim 7 wherein the wire includes at least one strain relief element.

16. The apparatus of claim 15 wherein the at least one strain relief element is fixed to the substrate.

17. The apparatus of claim 6 wherein the first temperature control source includes a frame surrounding the heating element and wherein the foil overlies the heating element and is either coupled to the frame or received within the frame.

18. An apparatus, comprising:
a first control compartment;
a second control compartment;
a first temperature control source received within the first control compartment and having a first substrate and a first heating element that is coupled to the first substrate; and
a second temperature control source having a second substrate, and a second heating element that is coupled to the second substrate, wherein the first and second heating elements are coupled electrically in series with one another.

19. The apparatus of claim 18 wherein both the first and second heating elements are defined by a single, continuous wire.

20. The apparatus of claim 19 wherein the wire includes a first portion coupled to the first substrate in a meandering pattern, a second portion coupled to the second substrate in a meandering pattern and a third portion extending between the first substrate and the second substrate.
